(19) United States
(12) Patent Application Publication
(10) Pub. No.: US 2017/0050696 A1
(43) Pub. Date: Feb. 23, 2017

(54) Collapsible Tricycle

(71) Applicant: Bernardo Beresnitzky, Brooklyn, NY (US)

(72) Inventor: Bernardo Beresnitzky, Brooklyn, NY (US)

(21) Appl. No.: 14/830,669

(22) Filed: Aug. 19, 2015

(51) Int. Cl. B62K 15/00; B62M 6/40; B62K 25/04; B62K 21/16; B62K 5/027; B62K 5/06

(52) U.S. Cl. CPC B62K 15/00; B62K 5/027; B62K 5/06; B62K 25/04; B62K 21/16; B62M 6/40; B62K 2204/00

(57) ABSTRACT

A collapsible tricycle having linkage to all three wheels enabling a smaller turning radius when all three wheels are tilted during a turn. The tricycle folds through the rear frame having a hinged rear axle with linkage to pivotal handle bars mounted to the rear frame that when pivoted from their storage position to their operative position also pivots the rear axle through said linkage from its stored position under the rear frame into its operative position. The rear axle is segmented so that when moved to its stored position under the rear frame each of the rear wheels can be pivotally collapsed against the frame.

### BACKGROUND OF THE INVENTION

Field of the Invention

The present invention relates generally to land vehicles and, more specifically, to a collapsible tricycle having a front frame portion and a rear frame portion with the front frame having linkage to all three wheels enabling a smaller turning radius when all three wheels are tilted during a turn.

Furthermore, the tricycle folds to a smaller footprint through the rear frame having a hinged rear axle with linkage to a pair of pivotal handle bars mounted to the rear frame that when pivoted from their storage position to their operative position also pivots the rear axle through said linkage from its stored position under the rear frame into its deployed operative position.

The rear axle is segmented so that when moved to its stored position under the rear frame each of the rear wheels can be pivotally collapsed against the frame.

The rear axle comprises a stationary subjacent axle portion and a movable superjacent axle portion with each hinged at their distal ends to a left and right rear wheel bracket with each bracket having an exteriorly extending spindle with a wheel mounted thereon. The wheel bracket has a top end and a bottom end connected to a respective superjacent movable portion and a bottom stationary portion with each wheel spindle positioned between the bracket's axle connections so that linear movement of the superjacent axle portion relative to the stationary subjacent axle portion causes the rear wheels to tilt in tandem.

The tricycle also provides adjustable linkage for moving the pedal assembly for either foot or hand power.

Furthermore, the collapsible tricycle provides a segmented front frame comprising a curvilinear rail-like segment and seat support segment fastened to the curvilinear rail-like segment where by pivoting the seat support segment causes a corresponding rotation of the curvilinear rail-like segment. Also provided is a seat adjustably attachable within a transverse slot in the seat support so that an operator steers the tricycle by shifting their weight causing the steering rail segment and curvilinear rail-like segment to pivot along with tilting the rear wheels in tandem. In operation, left movement of the seat results in a right turn of the front wheel with corresponding rear wheel camber and a right movement of the seat results in a left turn of the front wheel with corresponding rear wheel camber.

Description of the Prior Art

There are other land vehicles which provide for operator steering by shifting their weight. While these land vehicles may be suitable for the purposes for which they where designed, they would not be as suitable for the purposes of the present invention as heretofore described.

It is thus desirable to provide a tricycle having a seat support serving as steering rail with linkage extending to a rear axle superjacent movable axle portion so that when the seat support steering rail is moved to the left the front wheel turns to the right the superjacent rear axle movable portion tilts the rear wheel to the right and visa-versa when the operator moves the steering rail to the right thereby creating a smaller turning radius for said tricycle.

It is further desirable to provide a collapsible tricycle having linkage for moving the handles bars from a stored frame coplanar position to an operator selective tangential position with said handle bars having linkage to the tricycle rear axle which moves in tandem from a folded stored position to a deployed operative position.

### SUMMARY OF THE PRESENT INVENTION

A primary object of the present invention is to provide a collapsible tricycle having linkage for moving the handles bars from a stored frame coplanar position to an operator selective tangential position with said handle bars having linkage to the tricycle rear axle which moves in tandem from a folded stored position to a deployed operative position.

Another object of the present invention is to provide a collapsible tricycle having a front wheel frame and a rear wheels frame with said front wheels frame pivotally attached to said rear frame.

Yet another object of the present invention is to provide a collapsible tricycle wherein said front wheel frame segment comprises a curvilinear rail-like segment and seat support steering rail segment fastened to said curvilinear rail-like segment.

Still yet another object of the present invention is to provide a collapsible tricycle wherein said curvilinear rail-like segment has a pedal assembly mount selectively positionable and latchable to said curvilinear rail-like segment.

An additional object of the present invention is to provide a collapsible tricycle wherein said curvilinear rail-like segment further provides a spindle projecting tangently from the rear distal end providing mount for said seat support steering rail segment.

A further object of the present invention is to provide a collapsible tricycle wherein said seat support steering rail segment comprises a bar-like structure having a longitudinal portion extending into an obtuse angular portion wherein said longitudinal portion has a transverse slot for mounting a seat therein.

A yet further object of the present invention is to provide a collapsible tricycle wherein said seat support steering-rail segment obtuse-angular portion terminates in a fastenable clamp whereby said seat support steering rail segment mounts to the spindle of the curvilinear frame segment.

A still yet further object of the present invention is to provide a collapsible tricycle wherein said seat support steering-rail segment further provides linkage extending approximately from the steering wheel segment dog leg through a rear frame rotative steering linkage post then fastened to the movable superjacent rear axle portion causing the superjacent axle portion to move linearly relative to its stationary subjacent axle portion.

Another object of the present invention is to provide a collapsible tricycle having linkage means for varying the position of the guide wheel and pedal assembly mount.

Yet another object of the present invention is to provide a collapsible tricycle having means for adjusting the back rest of the seat in a vertical movement.

Still yet another object of the present invention is to provide a collapsible tricycle having means for adjusting the inclination of the back rest of the seat.

An additional object of the present invention is to provide a collapsible tricycle where the pedal assembly can be positioned whereby the rider can use their hands to power the vehicle.

A further object of the present invention is to provide a collapsible tricycle where the front wheel can be moved closer to or further from the rear axle.

A yet further object of the present invention is to provide a collapsible tricycle where the rider can steer the guide wheel by means of the seat by shifting their weight left and right.

Additional objects of the present invention will appear as the description proceeds.

The present invention overcomes the shortcomings of the prior art by providing a collapsible tricycle having a front wheel frame and a rear wheels frame with the front wheel frame having linkage to all three wheels enabling a smaller turning radius when all three wheels are tilted during a turn. The tricycle folds to a smaller footprint through the rear frame having a hinged rear axle with linkage to a pair of pivotal handle bars mounted to the rear frame that when extended from their storage position to their operative position also pivots the rear axle through said linkage from its stored position under the rear frame into its deployed operative position. The rear axle is segmented so that when moved to its stored position under the rear frame each of the rear wheels can be collapsed against the frame.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### DESCRIPTION OF THE REFERENCED NUMERALS

Turning now descriptively to the drawings, in which similar reference characters denote similar elements throughout the several views, the Figures illustrate the Foldable Tricycle of the present invention. With regard to the reference numerals used, the following numbering is used throughout the various drawing figures.
10 Foldable Tricycle of the present invention
12 user
14 frame
16 front wheel frame of 14
17 pedal assembly of 16
18 pedal assembly mount of 17
20 mount lock of 17
22 sprocket of 17
24 chain of 17
26 chain guides of 17
28 cranks of 17
32 pedals of 17
34 shock absorbers/suspension fork of 17
36 front wheel
38 cogset of 36
40 derailleur of 36
42 motor of 36
44 seat assembly spindle of 16
46 seat assembly of 16
48 seat support/steering rail segment of 16
50 seat of 48
52 steering linkage fastener of 48
54 steering linkage rail
56 rear wheels frame of 14
58 spindle bearing of 56
60 pivotal axle hinge of 56
62 rear axle of 56
64 rotative steering linkage post of 56
66 rail guide channel of 64
68 superjacent axle rail bracket
70 axle tether rail
72 pivot fastener of 70
74 handle bar bushing of 56
76 subjacent axle portion
78 hinged section of 76
80 spacers of 76
82 springs of 76
84 pivotal strut sections of 76
86 superjacent axle portion
88 hinged section of 86
92 pivotal strut sections of 86
94 rear wheels
96 bracket of 94
98 upper fastener apertures of 96
100 fastener of 98
102 lower fastener apertures of 96
104 fastener of 102
106 handlebar shaft in 74
108 handlebar pivot linkage of 106
110 pivot of 108
112 handle bar lock of 110
114 handlebar bar fastener
116 handlebar
118 handlebar grip/controls
120 axle extension linkage
122 axle extension strut of 120
124 struts shaft of 122
126 pivot strut of 120
128 strut pivot of 126
130 axle pivot of 126
132 latch of 120
134 shaft of 132
136 pivot of 134
138 pivotal bar of 132
140 pivot of 134, 138
142 open/closed stop cavity of 134
144 handle of 138
146 spring of 134
148 shock absorber of 86
150 pivot of 148
152 disc brake
154 cables of 152
P pressure

### BRIEF DESCRIPTION OF THE DRAWING FIGURES

In order that the invention may be more fully understood, it will now be described, by way of example, with reference to the accompanying drawing in which:

FIG. 1 is an illustrative view of the collapsible tricycle of the present invention.

FIG. 2 is a side view of the collapsible tricycle present invention.

FIG. 3 is a top deployed view of the tricycle present invention.

FIG. 4 is a top collapsed view of the tricycle present invention.

FIG. 5 is a top view of the tricycle in a left turn.

FIG. 5A is a partial rear view of the tricycle in a left turn.

FIG. 6 is a top view of the tricycle in a right turn.

FIG. 6A is a partial rear view of the tricycle in a right turn.

FIG. 7 is a perspective view of the tricycle with the seat and seat latching exploded.

FIG. 8 is a partial enlarged view, taken from FIG. 7 as indicated showing the axle extension linkage.

FIG. 9 is an illustrated view of the hinged rear axle folded beneath the rear wheels frame.

FIG. 10 is a partial enlarged view, taken from FIG. 9 as indicated, showing the axle extension linkage in a folded state.

FIG. 11 is an illustrated view of the hinged rear axle folded beneath the rear wheels frame with the wheels in dashed line.

FIG. 12 is an illustrated view of the tricycle of the present invention in the folded storage state.

FIG. 13A is a partial side view of the tricycle pedal assembly incorporating movable chain guides.

FIG. 13B is a side view of the tricycle with movable pedal assembly incorporating movable chain guides.

FIG. 13C is a side view of the pedal assembly having chain guides.

FIG. 13D is a front view of the pedal assembly having chain guides.

FIG. 14 is a side view of the tricycle of the present invention having chain guides in use.

FIG. 15A is a side view of pedal assembly incorporating chain guides and pedal assembly post.

FIG. 15B is a side view of the pedal assembly having chain guides and pedal assembly post.

FIG. 15C is a front view of the pedal assembly having chain guides and pedal assembly post.

FIG. 16 is a side view of the tricycle of the present invention having chain guides and post in hand use.

FIG. 17A is a side view of pedal assembly incorporating chain guides and slidable pedal assembly.

FIG. 17B is a side view of the slidable pedal assembly incorporating chain guides.

FIG. 17C is a front view of the pedal assembly having chain guides and slidable pedal assembly.

FIG. 18 is a partial front view of the slidable pedal assembly mounted onto the front frame of the tricycle of the present invention.

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

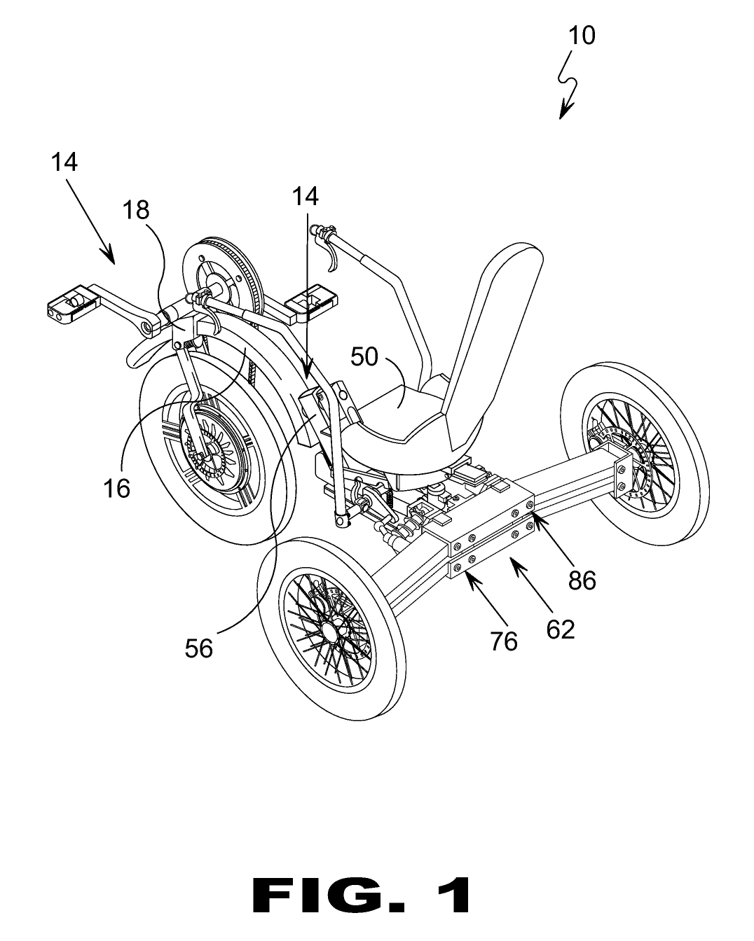

Referring to FIG. 1, shown is an illustrative view of the tricycle of the present invention. The present invention is a foldable tricycle 10 having a split frame 14 comprising a front wheel frame 16 and a rear wheels frame 60 having a pivotal rear axle 62 comprising a subjacent axle portion 76 and superjacent axle portion 86 that moves linearly left/right relative to the subjacent axle portion 74 through the user pivotally moving the tricycle seat 50 by leaning left whereupon the front wheel turns to the right in tandem seat linkage to the superjacent axle portion 86 tilts the rear wheels in the same direction as the front wheel and by leaning right the front wheel turns to the left in tandem seat linkage to the superjacent axle portion 86 tilts the rear wheels in the same direction as the front wheel. Also shown is pedal assembly 17 slidably mounted onto the front wheel frame 16.

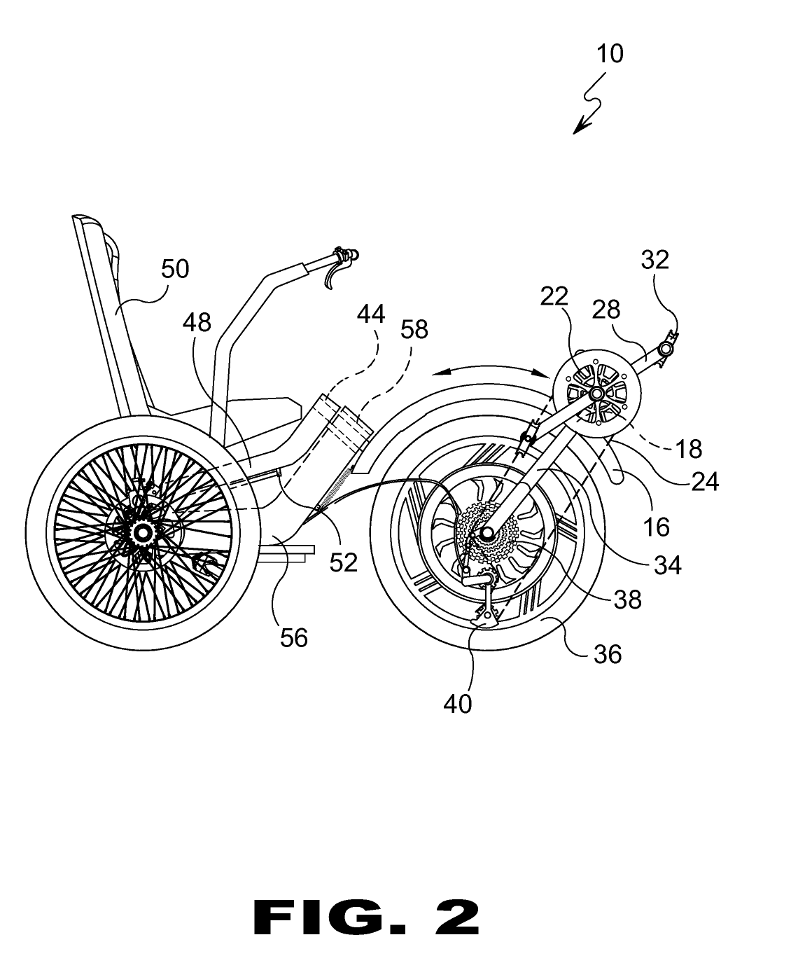

Referring to FIG. 2, shown is a side view of the present invention. The foldable tricycle 10 of the present invention has a front wheel frame 16 with a slideable pedal assembly bracket 18 mounted approximate one end and seat assembly mounting spindle 44 approximate the other end of frame 16. Rear wheel frame 56 provides bearing 58 mounted onto spindle 44 providing a rotative front wheel frame 16. Seat assembly 46 comprises seat support 48 that is mounted onto spindle 44 and seat 50 that is mounted onto and selectively positionable on seat support 48.

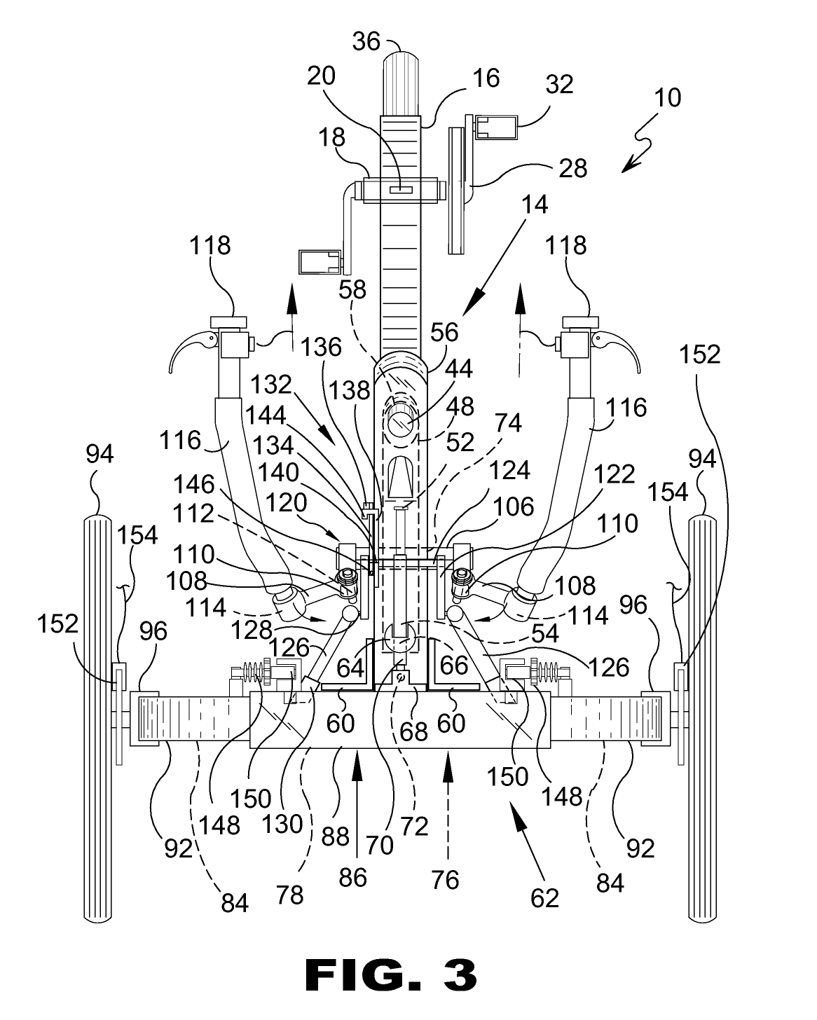

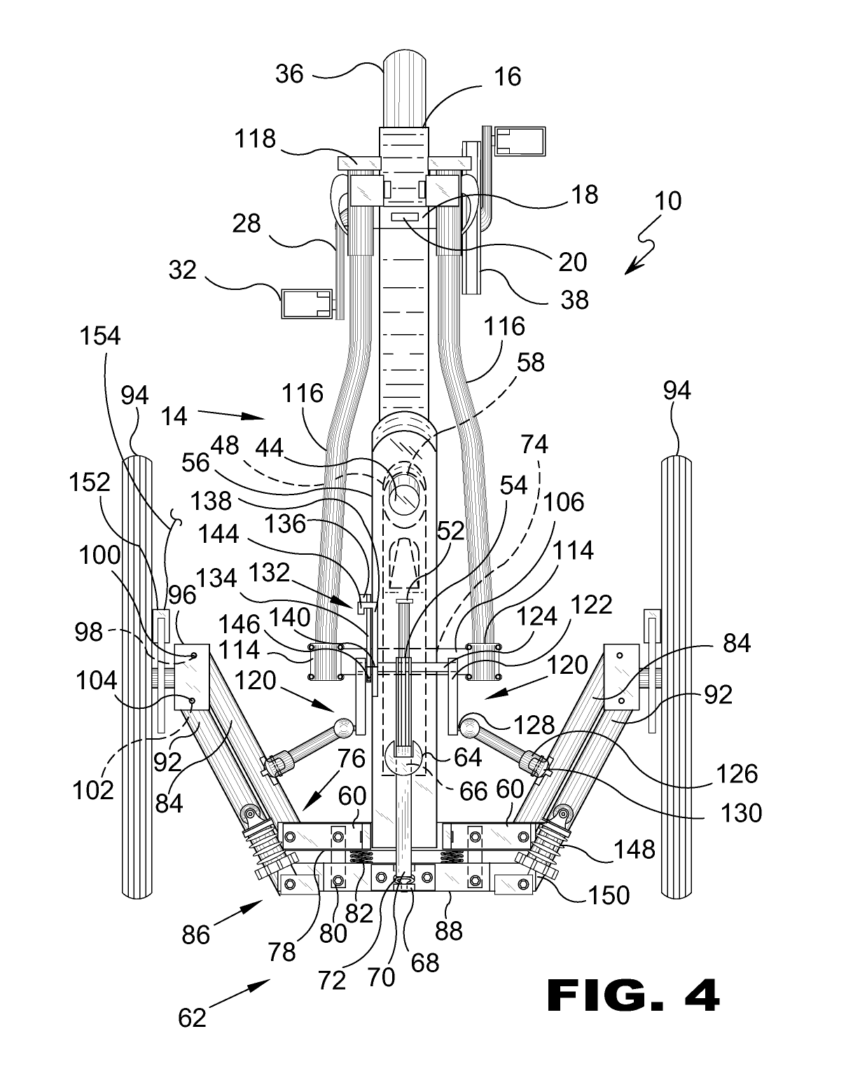

Referring to FIG. 3 and FIG. 4, respectively shown is a top view of the tricycle of the present invention in a deployed operative position and a top view of the tricycle in a folded storage position. The foldable tricycle 10 of the present invention comprises frame 14 having a front wheel frame 16 and a rear wheel frame 56 with a rear axle 62 comprising a superjacent axle portion 86, subjacent axle portion 76 and axle extension linkage 120 that deploys and folds the rear axle 62 beneath the rear wheel frame 56 via linkage 108.

In FIG. 3, handlebar pivot linkage 108 has fastener 114 that receives handle bar 116, forming a somewhat right angle with fastener 114, on one distal end and on the other end pivot joint 110 is fixedly attached to handlebar shaft 106 with handlebar lock 112, shown in dashed line for clarity, to fixedly position the handlebars 116 in a user desired operative location.

Handlebar 116 that is rigidly attached via fastener 114 to handlebar pivot linkage 108 has two operative states. In a folded state, shown in FIG. 4, respective handlebars 116 extend in co-planar fashion toward the tricycle front with the hinged axle lying under the rear wheel frame 56 with tether rail 70 extended.

Several linkages are provided for controlling the deployment and retraction of the rear axle 62. Rear axle 62 is pivotally attached to rear wheels frame 56 by hinge 60. Frame 56 also has bushing 74 with handlebar shaft 106 therein. Attached to shaft 106 is axle extension linkage 120 comprising fixedly attached axle extension struts 122, struts shaft 124 fixedly attached to a respective strut 122 and pivot struts 126 pivotally attached to a respective subjacent pivotal strut 84 through axle pivot 130, shown in FIG. 4, at one end and having strut pivot 128 on the other end.

Rear frame 56 also provides superjacent axle rail bracket 68 having pivot fastener 72 attached to axle tether rail 70, which is extended when the bike axle is in the folded state, shown in FIG. 4. A subjacent steering linkage rail 54, which is part of the steering linkage extending from steering linkage fastener 52 fixedly attached to seat support 48, through the rail guide channel 66 of rotative steering linkage post 64 then fastened to superjacent axle rail bracket 68, has longitudinal tracks with the tether rail 70 having mating channels so that in an operative state the rails matingly overlay serving to move the superjacent axle portion 86 relative to the subjacent axle portion 76 either left or right by the user leaning and thereby moving the seat support 48 in the desired direction.

The split rail then serves two functions; when overlaying each other the rails mate and are used to steer the bike, when folded the mating rails—tracks and channels—keep the steering mechanism rails aligned and aid in guiding the tether rail when moving rear axle 62 to a deployed position.

The second handlebar operative state (deployed position) is to deploy the rear axle 62 using the handlebars and attached axle extension linkage 120.

As aforementioned, the handlebars 116 are collapsed longitudinally against the bike in the folded state with the rear axle 62 folded under the rear frame and tether rail 70 extended.

Handlebars 116 and pivot linkages 108 provide torque in rotating handlebar shaft 106 and fixedly attached struts 122 and strut shaft 124 driving to a deployed position pivot struts 126 fastened to a respective subjacent strut 84 through axle pivot 130, shown in FIG. 4. Concurrently, hinged section 78 of subjacent axle portion 76 is pivotally driven to a deployed state through pivotal axle hinge 60 pivotally attached to rear frame 56. Simultaneously, the tether rail 70 in its extended position having one end within rail guide channel 66 and its channels engaging the tracks of steering rail 54 is driven by rail bracket 68 fastener 72 attached to hinged section 88 of superjacent axle portion 86 to overlay rail 54 wherethen the bike is deployed to its operative state, as shown in FIG. 3.

Further provided is steering linkage latch 132 holding the steering linkage 120 in either a folded position or a deployed operative position comprising shaft 134 attached to rear frame 56 by pivot 136, pivot bar 138 having handle 144 and pivot 140. Handle 144 pivots the pivot bar raising shaft 134 having respective open/closed stop cavities 142, that latch onto the axle extension strut 122 in a respective cavity of shaft 134 when the tricycle is in a folded state or a deployed operative state. Extension strut 122 also provides a tension spring 146 that will return strut 122 to a seated position when handle 144 is released. As a safety feature, since the handlebars can be pivoted inward then moved forward and downward, which can fold the rear axle and extend the tether rail, the latching locks the axle extension linkage 120 in either a deployed or folded position.

Rear axle 62 comprises superjacent axle portion 86 and subjacent axle portion 76 with each having respective hinged portions 78, 88 and distal end struts 84, 92, shown clearly in FIG. 4. Positioned within the opposing hinged strut sections 78, 88 are a pair of pivotal spacers, 80 and springs 82 enabling the superjacent hinged portion 88 to longitudinally move left or right over the subjacent hinged portion 78. Shock absorbers 148 are pivotally attached 150 to distal ends of superjacent hinge section 88 and fixedly attached to a respective strut 92. Superjacent struts 92 are attached to the top end apertures 102 of wheel bracket 96 by fasteners 104 and subjacent struts 84 are attached to the bottom end apertures 98 by fasteners 100. Wheel brackets 96 are rigidly attached to respective wheels 94 so that simultaneously wheel camber is produced by longitudinal movement of the superjacent hinged section 88 through a respective strut 92 tilting a wheel either left or right.

Also shown are wheels 94 having disk brakes 152 and brake cables 154, which extend (not shown) to handlebar controls 118. Further illustrated is pedal assembly mount 18 slidably mounted onto front wheel frame 16 having mount lock 20 for selectively fastening 18 at a desired location.

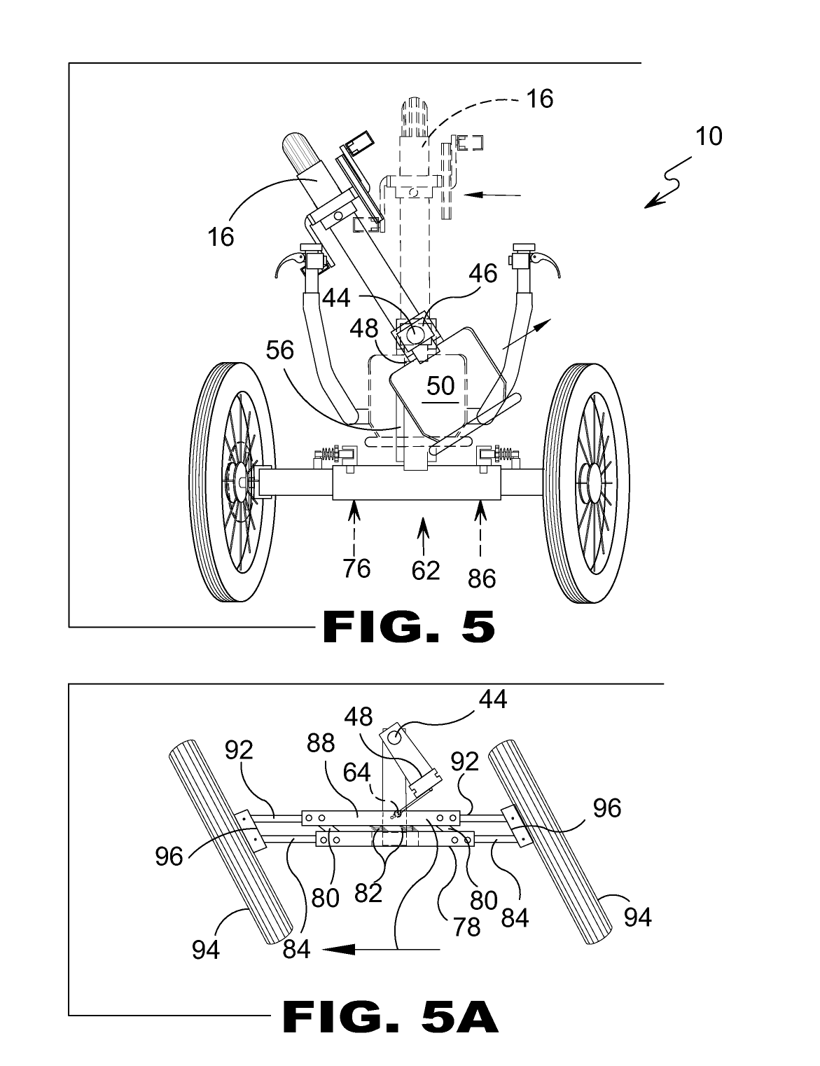

Referring to FIG. 5 and FIG. 5A, depicted is a top view of the tricycle in a left turn and a back view of the rear axle's position. FIG. 5 illustrates the tricycle 10 having a front wheel frame 16 having seat assembly 46 with seat support 48 mounted to spindle 44 and a rear wheels frame 56 having rear axle 62 with a subjacent axle portion 76 and a superjacent axle portion 86 that linearly moves relative to the subjacent axle portion 76 through linkage extending from seat support 48 through rear frame rotative linkage post 64 to superjacent axle 84 depicted in FIG. 5A.

Referring to FIG. 6 and FIG. 6A, depicted is a top view of the tricycle in a right turn and a back view of the rear axle's position. FIG. 6 illustrates the tricycle 10 having a front wheel frame 16 having seat assembly 46 with seat support 48 mounted to spindle 44 and a rear wheels frame 56 having rear axle 62 with a subjacent axle portion 76 and a superjacent axle portion 86 that linearly moves relative to the subjacent axle portion 76 through linkage extending from seat support 48 through rear frame rotative linkage post 64 to superjacent axle 86 depicted in FIG. 6A.

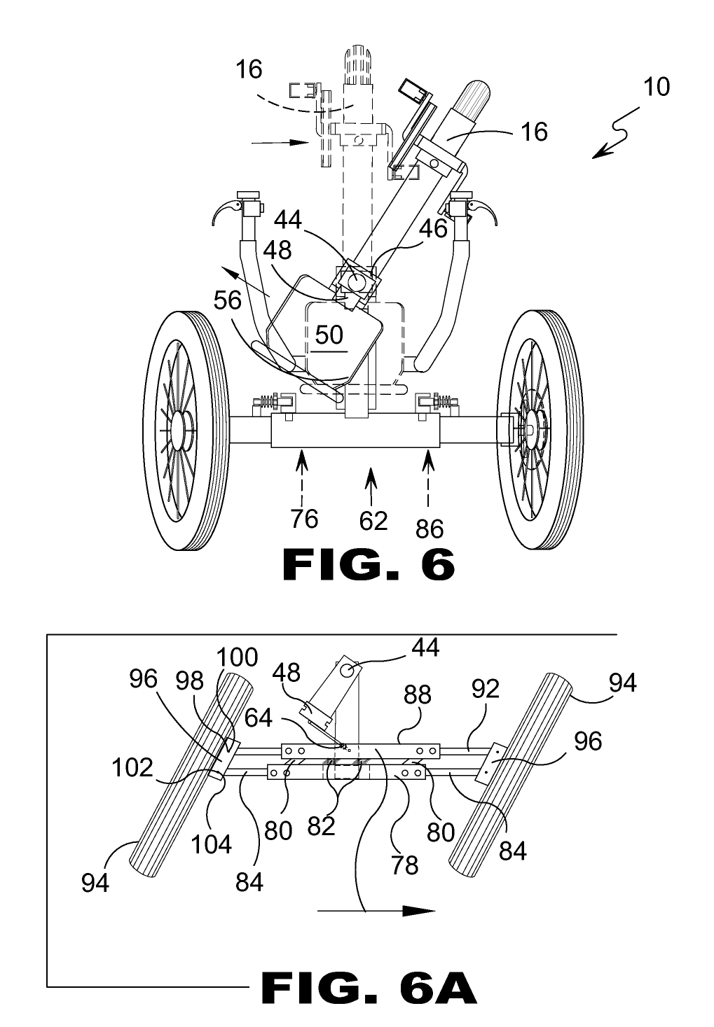

Referring to FIG. 7, shown is a perspective view of the tricycle of the present invention. Illustrated is the tricycle 10 having a seat support 48 mounted on spindle 44 of front wheel frame 16. Seat assembly 46 comprises seat support 48 forming mount for seat 50 and steering linkage fastener 52 so that when seat support 48 is moved in one direction the steering linkage extending through linkage post 64 of rear wheel frame 56 moves superjacent axle 84 in the opposite direction, which then tilts the rear wheels 94 via wheel bracket 96 in the same direction as the front wheel 36.

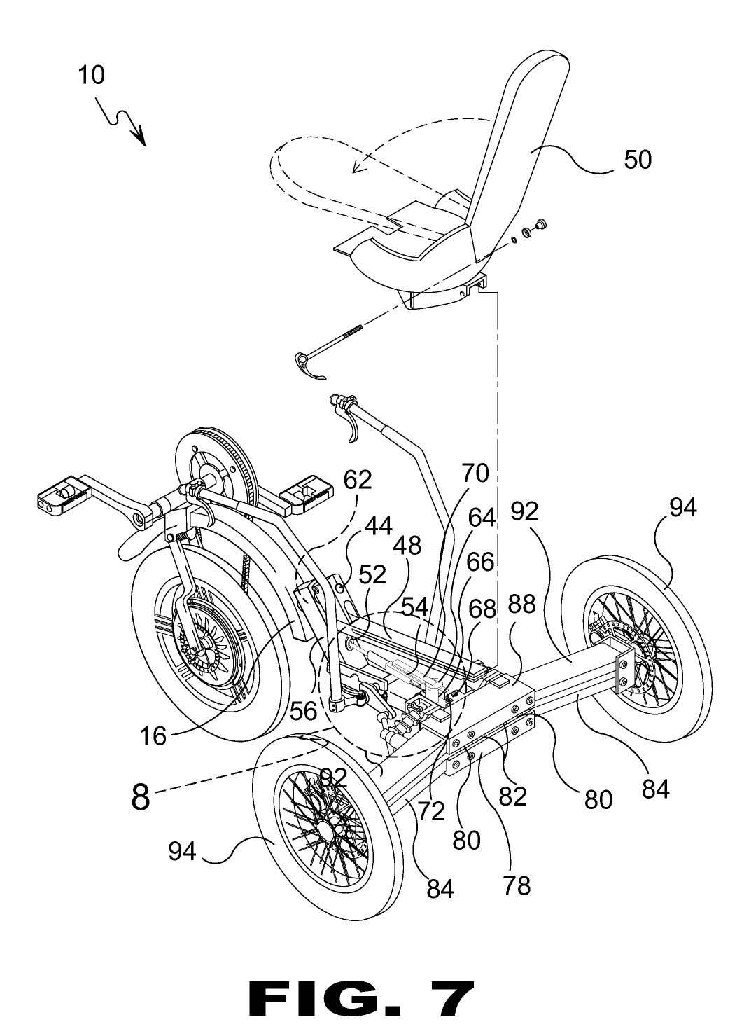

Referring to FIG. 8, depicted is a partial enlarged view, taken from FIG. 7 as indicated, showing the axle extension linkage. The axle extension linkage 120 has a pair of extension struts 122 and pivot struts 126 with the extension struts fixedly attached to pivotal handlebar shaft 106 and pivot struts having pivots on each distal end. Strut pivot 128 links strut 122 with strut 126 and axle pivot 130 attached to a respective subjacent strut 84. To collapse the bicycle to a folded state the handle bar lock 112 is unlatched allowing the handlebars 116 to be pivoted inward through pivot 110 of pivot linkage 108. Once pivoted the handlebars 116 and pivot linkage 108 are substantially perpendicular to handlebar shaft 106 providing optional torque in folding the rear axle 62 under rear frame 56 through the axle extension linkage 120.

Referring to FIG. 9, illustrated is the hinged rear axle folded beneath the rear wheels frame. Several linkages are provided for controlling the deployment and retraction of the rear axle 62. Rear axle 62 is pivotally attached to rear wheels frame 56 by hinge 60. To collapse the bicycle to a folded state the handle bar lock 112 is unlatched allowing the handlebars 116 to be pivoted inward through pivot 110 of pivot linkage 108. Once pivoted the handlebars 116 and pivot linkage 108 are substantially perpendicular to handlebar shaft 106 providing optional torque in folding the rear axle 62 under rear frame 56 by pushing the handlebars 116 down thereby rotating handlebar shaft 106 and fixedly attached axle extension strut 122 pivoting pivot strut 126 having pivot 128. Pivot strut 126 having pivot 128 attached to strut 122 is also pivotally attached to subjacent pivotal strut section 84, which then pivots rear axle 62 beneath the rear wheels frame 56.

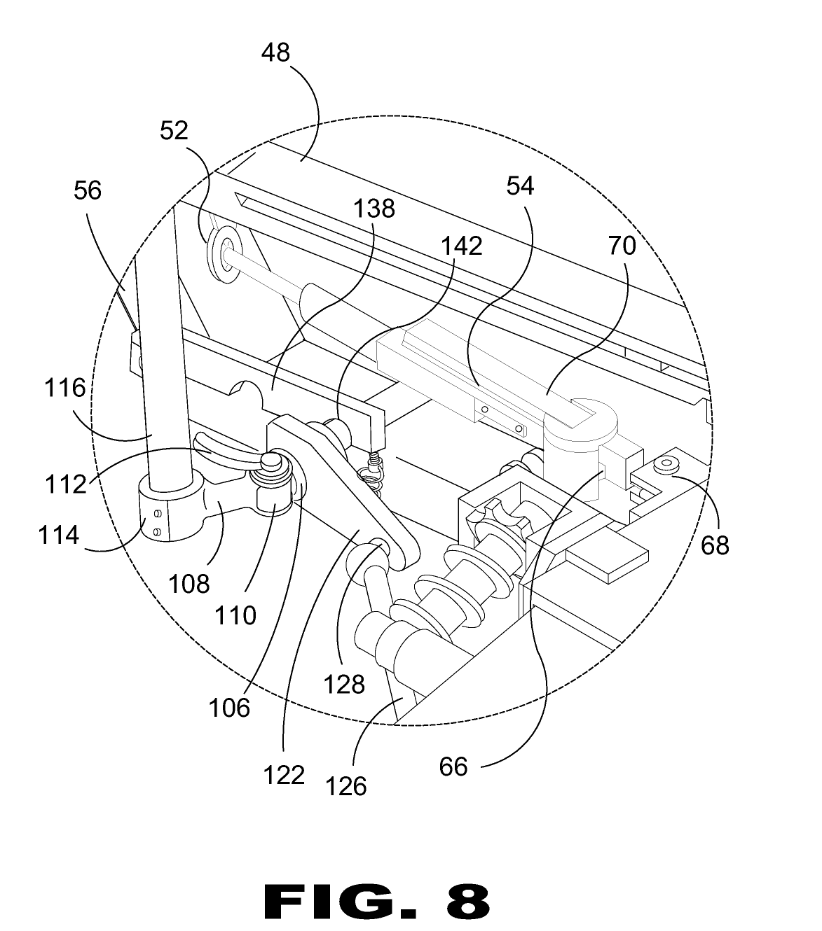

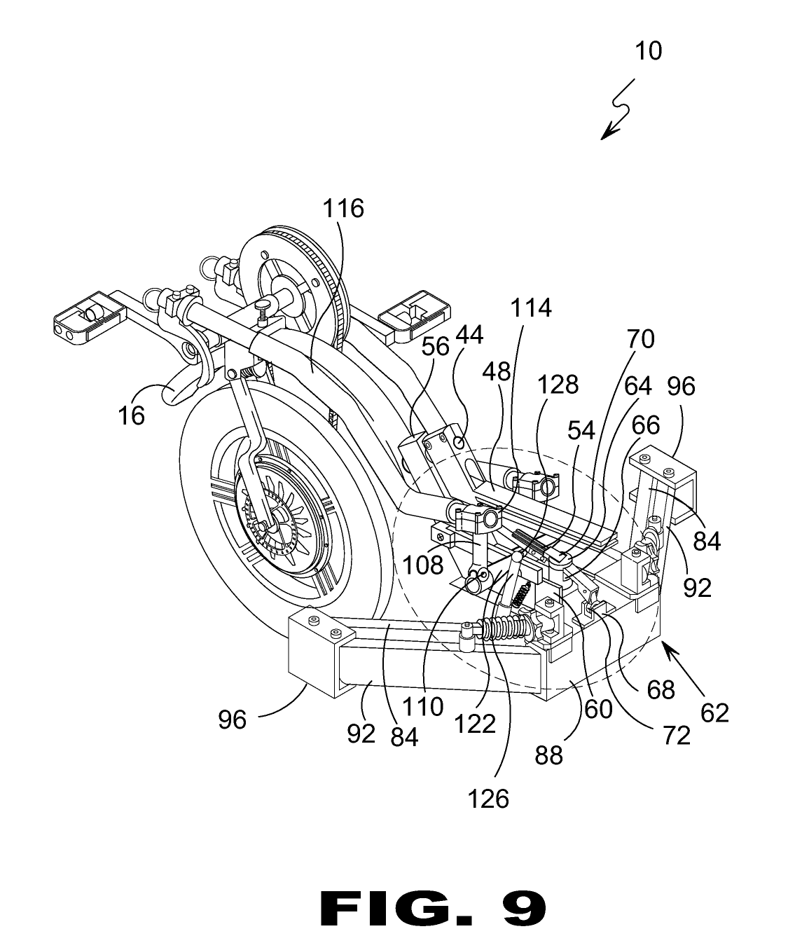

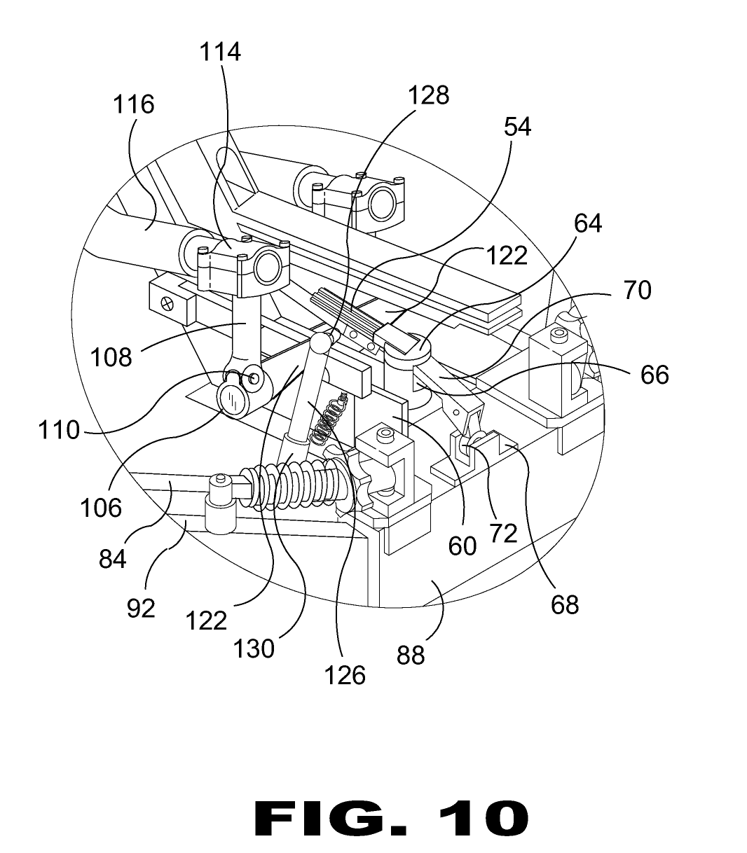

Referring to FIG. 10, depicted is a partial enlarged view, taken from FIG. 9 as indicated, showing the axle extension linkage in a folded state. The axle extension linkage 120 has a pair of extension struts 122 and pivot struts 126 with the extension struts fixedly attached to pivotal handlebar shaft 106 and pivot struts having pivots on each distal end. Strut pivot 128 links strut 122 with strut 126 and axle pivot 130 attached to a respective subjacent strut 84. To collapse the bicycle to a folded state the handle bar lock 112 is unlatched allowing the handlebars 116 to be pivoted inward through pivot 110 of pivot linkage 108, which is then substantially perpendicular to handlebar shaft 106 with the handlebars 116 at a substantial right angle to shaft 106 wherethen handlebars 116 are used to produce torque in moving the tricycle rear axle 62 beneath rear wheels frame 56.

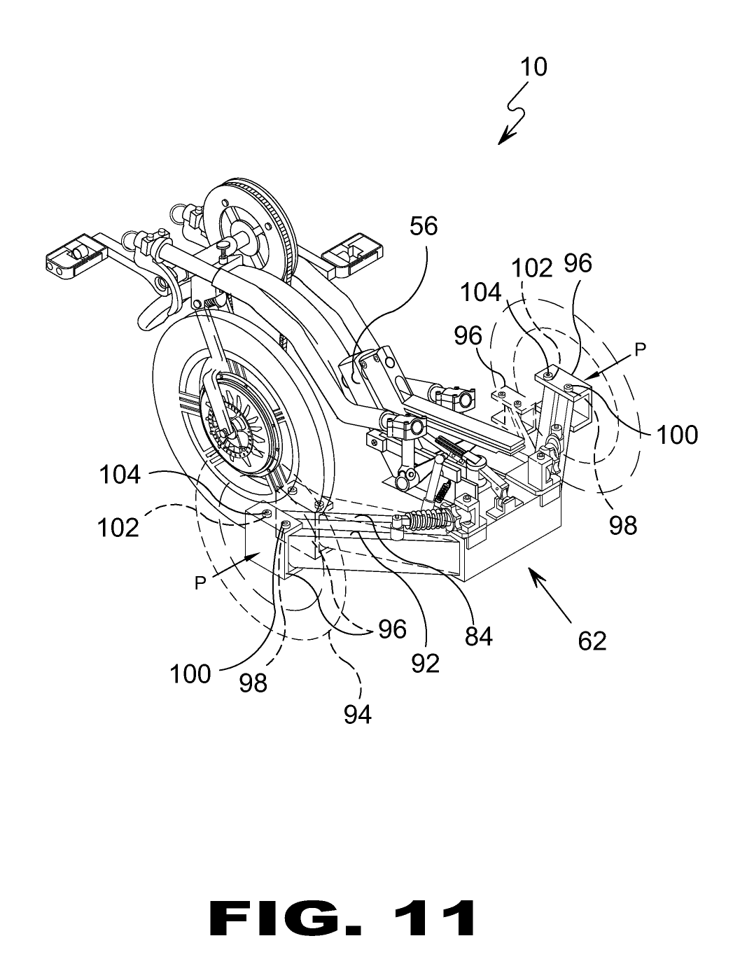

Referring to FIG. 11, shown is the rear axle folded beneath the rear wheels frame. Once the rear axle 62 has been folded beneath the rear wheels frame 56, inward pressure applied to wheels 94, shown in dashed line, pivots the superjacent and subjacent pivotal strut sections 84, 92 against the folded tricycle 10. The pivotal strut sections, 84, 92 are pivotally attached to a respective hinged section 76, 86 with the respective wheel bracket 96 providing apertures 98 and fasteners 100 that pivotally fastens subjacent pivotal struts 84 to said wheel bracket and providing apertures 102 and fasteners 104 that pivotally fastens superjacent pivotal struts 92 to said wheel bracket.

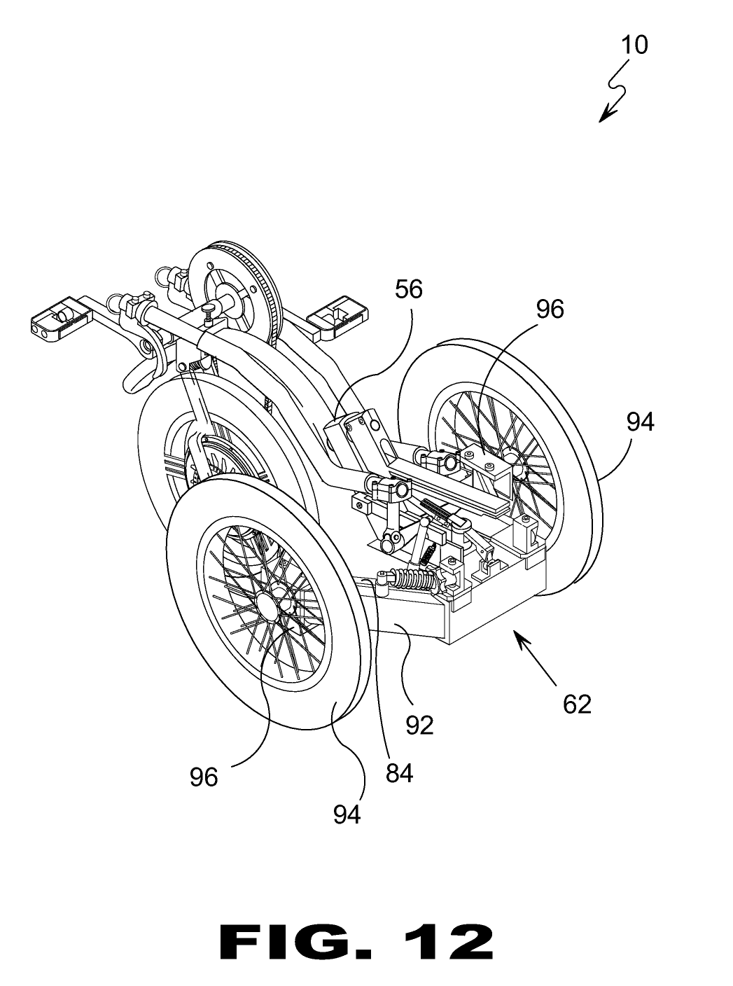

Referring to FIG. 12, shown is the rear axle folded beneath the rear wheels frame. Once the rear axle 62 has been folded beneath the rear wheels frame 56, inward pressure applied to wheels 94, pivots the superjacent and subjacent pivotal strut sections 84, 92 against the folded tricycle 10. The pivotal strut sections, 84, 92 are pivotally attached to a respective hinged section 76, 86 with the respective wheel bracket 96 providing apertures 98 and fasteners 100 that pivotally fastens subjacent pivotal struts 84 to said wheel bracket and providing apertures 102 and fasteners 104 that pivotally fastens superjacent pivotal struts 92 to said wheel bracket.

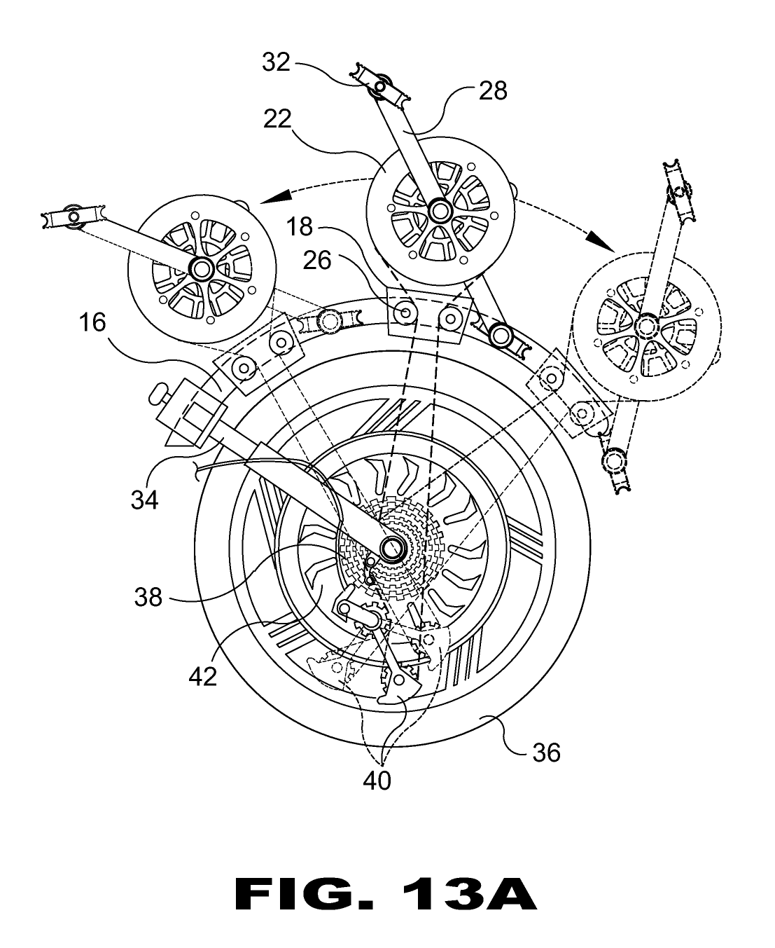

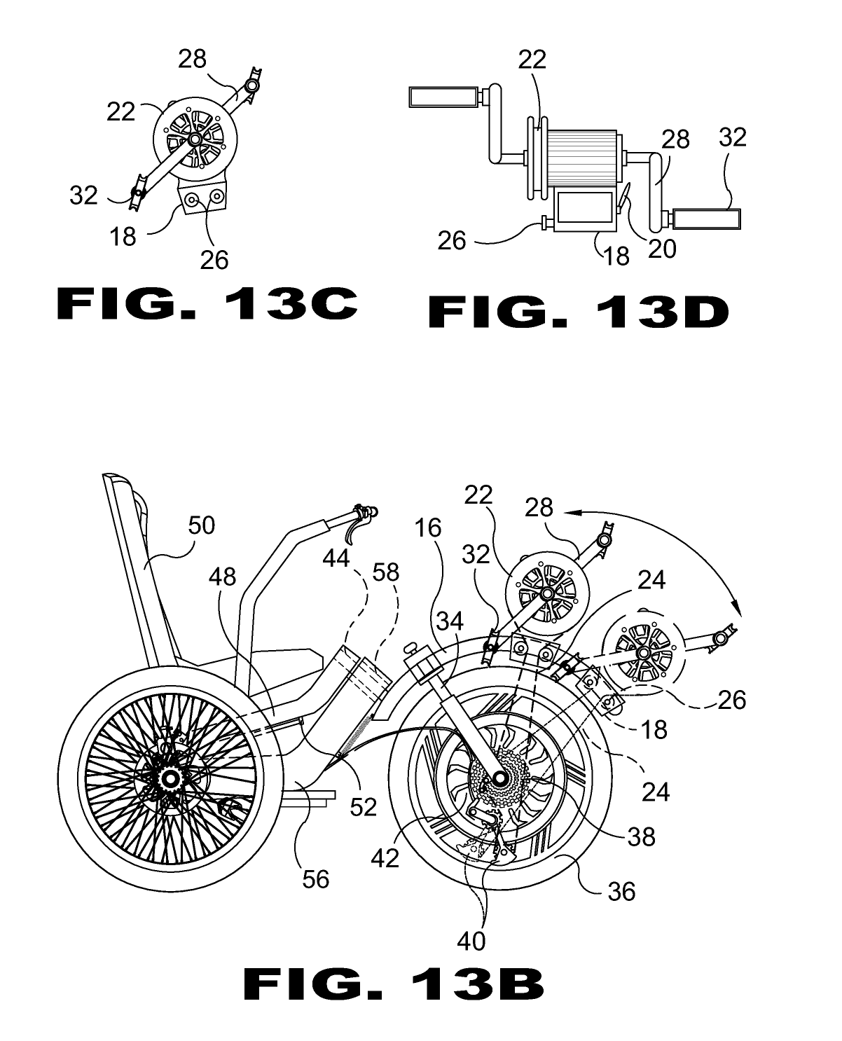

Referring to FIG. 13A through 13D, shown is a side view of the tricycle of the present invention having a slidable pedal assembly and side and front views of the pedal assembly. FIG. 13A is a side view of the tricycle front end having front wheel frame 16 with a slideable pedal assembly bracket 18 thereon with chain guides 26 mounted thereto. Also shown are sprocket 22, crank 28 and pedals 32. Front frame 16 has shock absorbers 34 fastened to the front wheel spindle having cogset 38, wheel 36, motor 42 and derailleur 40 mounted thereon. FIG. 13B shows the foldable tricycle 10 of the present invention having a front wheel frame 16 with a slideable pedal assembly bracket 18 mounted on the tricycle front frame portion 16 and seat support 48 mounted onto the front frame spindle 44. Rear wheel frame 56 provides bearing 58 mounted onto spindle 44 providing a rotative front wheel frame 16. Seat assembly 46 comprises seat support 48 that is mounted onto spindle 44 and seat 50 that is mounted onto and selectively positionable on seat support 48. FIG. 13C shows a side view of the pedal assembly and FIG. 13D shows a front view of the pedal assembly comprising pedal assembly mount 18 having mount lock 20, and chain guides 26, with sprocket 22, crank 28 and pedals 32.

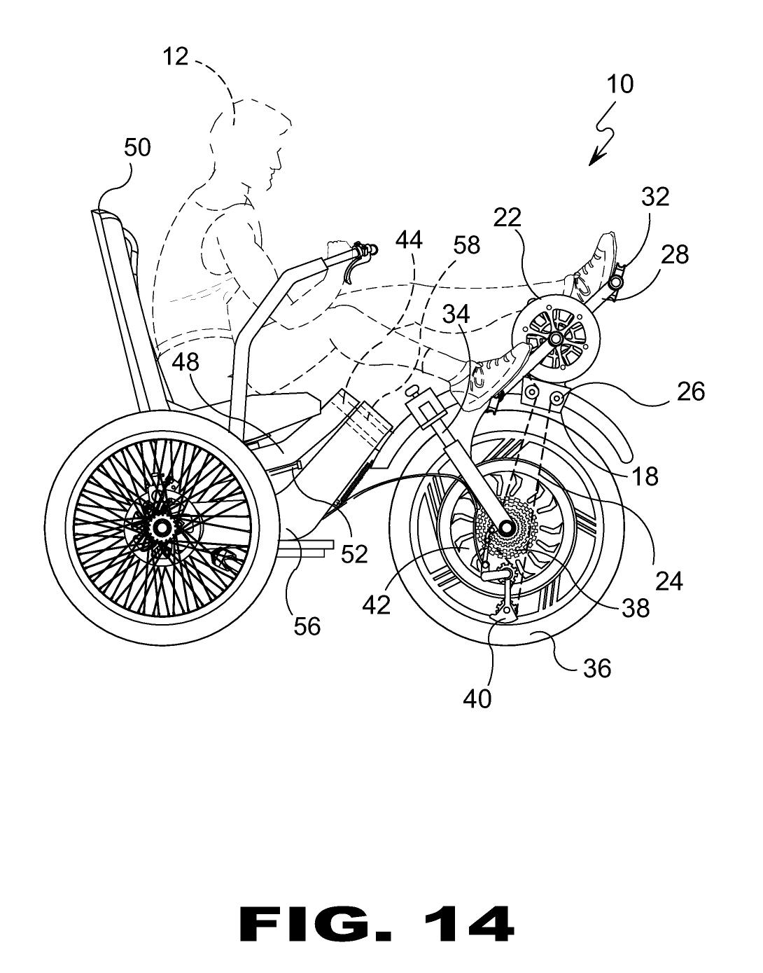

Referring to FIG. 14, shown is a side view of the tricycle of the present invention having a slidable pedal assembly in use. The foldable tricycle 10 of the present invention having a front wheel frame 16 with a slideable pedal assembly bracket 18 mounted on the tricycle front frame portion 16 and seat support 48 mounted onto the front frame spindle 44. Rear wheel frame 56 provides bearing 58 mounted onto spindle 44 providing a rotative front wheel frame 16. Seat assembly 46 comprises seat support 48 that is mounted onto spindle 44 and seat 50 that is mounted onto and selectively positionable on seat support 48. The slidable pedal assembly 17 comprises pedal assembly mount 18 having mount lock 20, and chain guides 26, with sprocket 22, crank 28 and pedals 32.

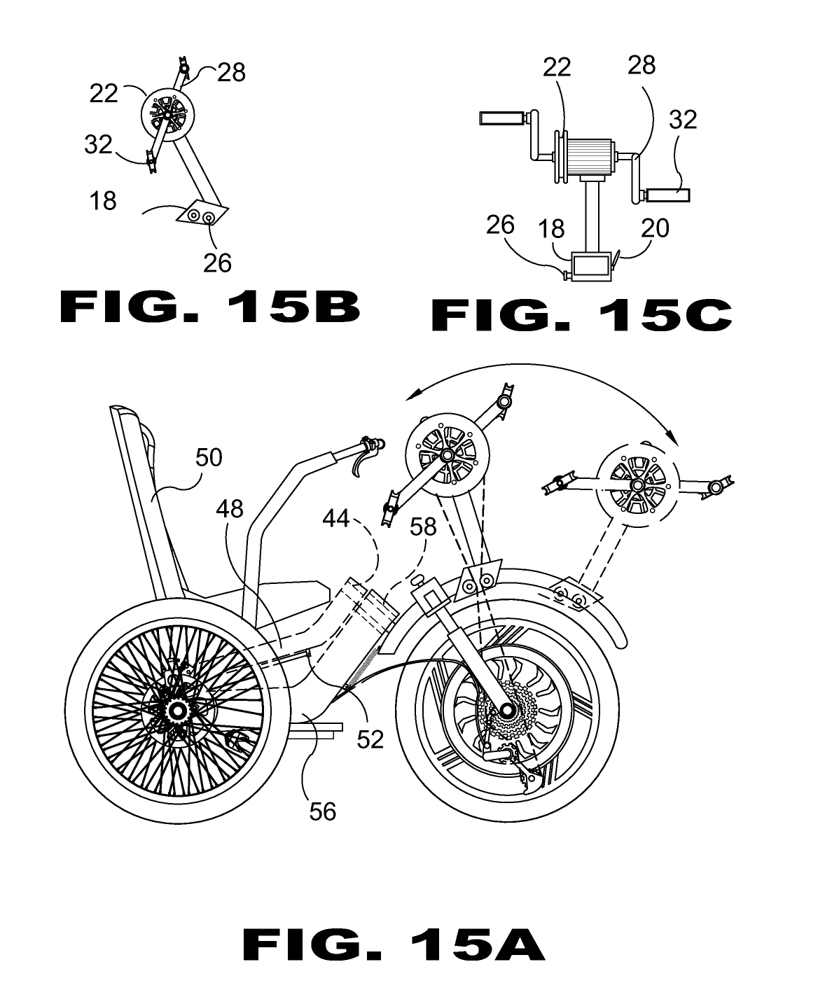

Referring to FIG. 15A through 15C, shown is a side view of the tricycle of the present invention having a slidable pedal assembly and side and front views of the pedal assembly. FIG. 15A shows the foldable tricycle 10 of the present invention having a front wheel frame 16 with a slideable pedal assembly bracket 18 mounted on the tricycle front frame portion 16 and seat support 48 mounted onto the front frame spindle 44. Rear wheel frame 56 provides bearing 58 mounted onto spindle 44 providing a rotative front wheel frame 16. Seat assembly 46 comprises seat support 48 that is mounted onto spindle 44 and seat 50 that is mounted onto and selectively positionable on seat support 48. FIG. 15B shows a side view of the pedal assembly and FIG. 15C shows a front view of the pedal assembly comprising pedal assembly mount 18 having mount lock 20, and chain guides 26, with sprocket 22, crank 28 and pedals 32 enabling the user to adjust the distance between the pedal assembly and their arm length.

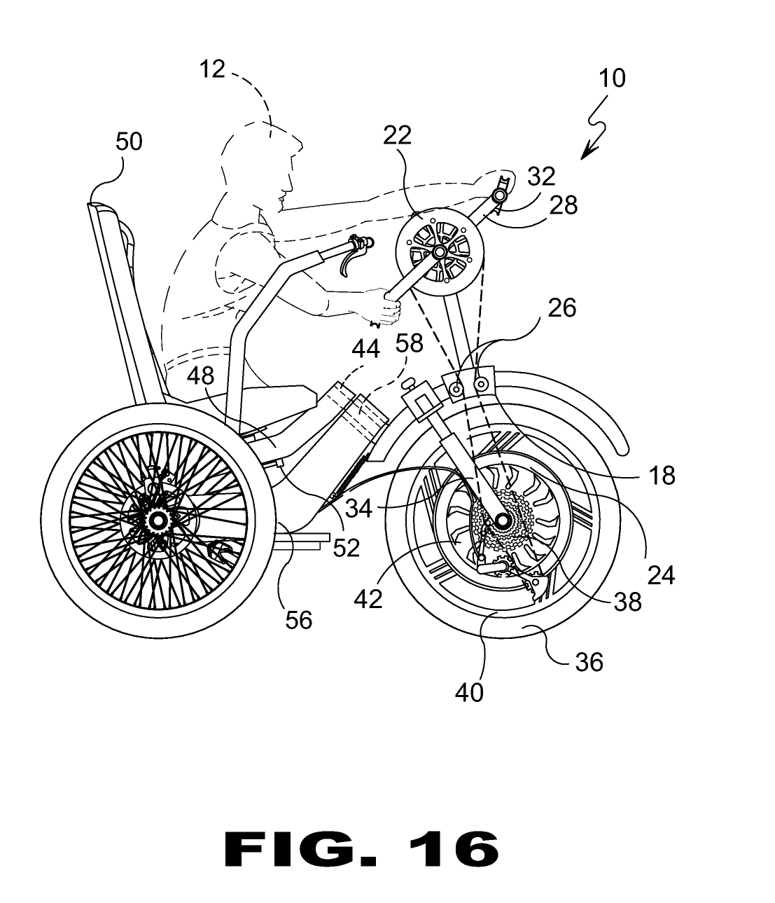

Referring to FIG. 16, shown is a side view of the tricycle of the present invention having chain guides and post in hand use. Shown is the foldable tricycle 10 of the present invention having a front wheel frame 16 with a slideable pedal assembly bracket 18 mounted on the tricycle front frame portion 16 and seat support 48 mounted onto the front frame spindle 44. Rear wheel frame 56 provides bearing 58 mounted onto spindle 44 providing a rotative front wheel frame 16. Seat assembly 46 comprises seat support 48 that is mounted onto spindle 44 and seat 50 that is mounted onto and selectively positionable on seat support 48. The pedal assembly provides pedal assembly mount 18 having mount lock 20, and chain guides 26, with sprocket 22, crank 28 and pedals 32 mounted to a post enabling the user to adjust the distance between the pedal assembly and their arm length.

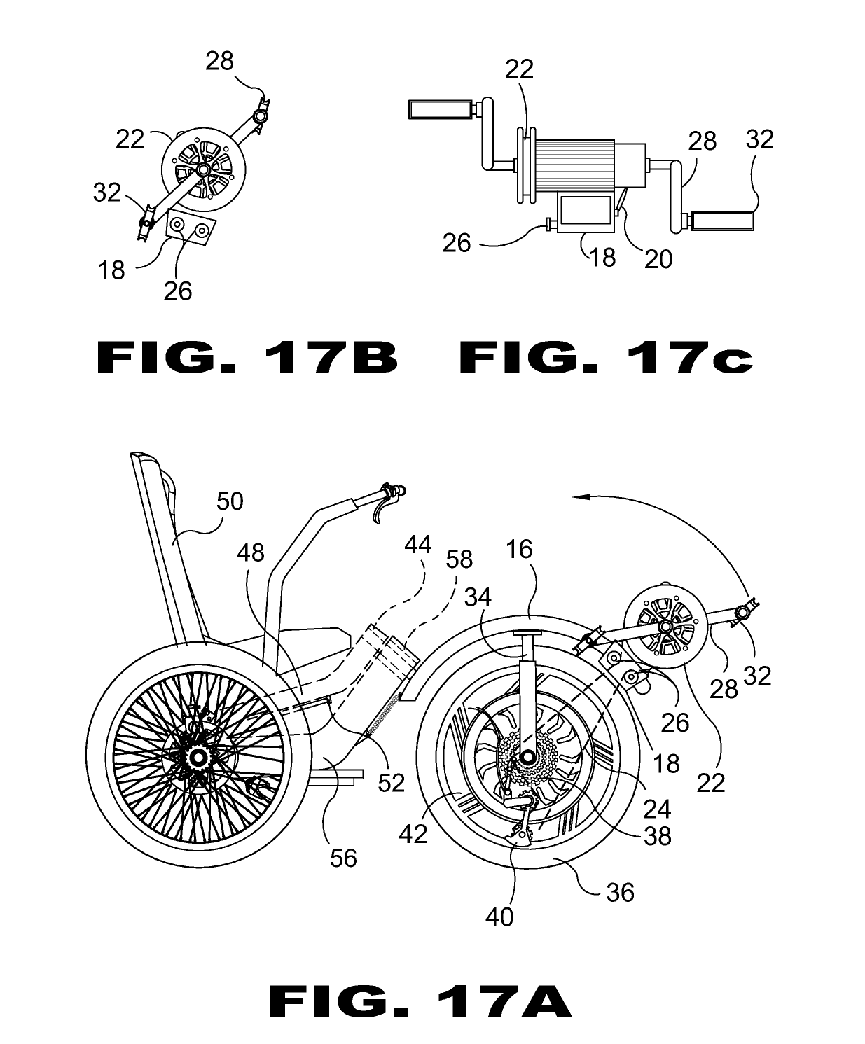

Referring to FIG. 17A through 17C, shown is a side view of the tricycle of the present invention having a slidable pedal assembly and side and front views of the pedal assembly. FIG. 17A shows the foldable tricycle 10 of the present invention having a front wheel frame 16 with a slideable pedal assembly bracket 18 mounted on the tricycle front frame portion 16 and seat support 48 mounted onto the front frame spindle 44. Rear wheel frame 56 provides bearing 58 mounted onto spindle 44 providing a rotative front wheel frame 16. Seat assembly 46 comprises seat support 48 that is mounted onto spindle 44 and seat 50 that is mounted onto and selectively positionable on seat support 48. FIG. 17B shows a side view of the pedal assembly and FIG. 17C shows a front view of the pedal assembly comprising pedal assembly mount 18 having mount lock 20, and chain guides 26, with sprocket 22, crank 28 and pedals 32 enabling the user to adjust the distance between the pedal assembly and their leg length.

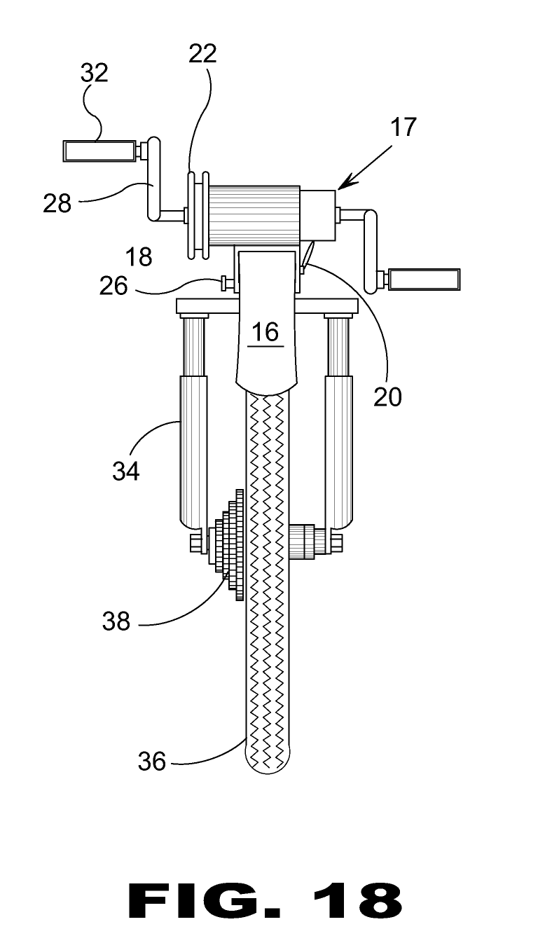

Referring to FIG. 18, shown is a partial front view of the tricycle of the present invention. Shown is the front frame 16 having pedal assembly 17 mounted thereon. Front frame 16 has shock absorbers 34 fastened to the front wheel spindle having cogset 38 and wheel 36 mounted thereto. Also shown is mount 18 having latch 20 for fixedly attaching the pedal assembly in a desired location and chain guides 18 enable the mount to slide along front frame 16.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent and is set forth in the appended claims:

1. A foldable three wheel land vehicle comprising:
a) a curvilinear front wheel frame forming a rail having a front end and a back end having a spindle tangently projecting therefrom with said front end having a slidable pedal assembly mounted thereon and fixedly positionable thereto;
b) said pedal assembly fixedly attached to a respective shock absorber with the shock absorbers terminal end fixedly attached to a front wheel axle;
c) a rear wheels frame having a front end and a back end with said front end having a bearing whereby said front frame is pivotally fastened by said spindle to said rear frame; and
d) said rear wheels frame back end having a hinged rear axle with wheels mounted on its terminal ends that is movable between a folded state where said rear axle is beneath the rear wheels frame and a deployed state where said rear axle extends from said rear wheels frame

2. The foldable three wheel land vehicle of claim 1, wherein said rear axle comprises a superjacent axle portion and a subjacent axle portion with a pair of spacers and springs positioned between said axle portions so that the superjacent axle portion can linearly move left and right relative to the subjacent axle portion.

3. The foldable three wheel land vehicle of claim 2, wherein each of said rear axle portions has a hinged section with opposing ends having pivotal strut sections extending therefrom that are fastened to respective wheel brackets having superjacent and subjacent apertures for securing a corresponding superjacent and subjacent strut section to a respective wheel bracket aperture having a wheel attached thereto.

4. The foldable three wheel land vehicle of claim 3, further providing a seat assembly having a seat support fastened to said spindle that angularly extends to a rail with a seat mountable thereon so that an operator steers the tricycle by shifting their weight either left or right causing the steering rail segment and curvilinear rail-like segment to pivot in tandem.

5. The foldable three wheel land vehicle of claim 4, further providing said rear wheels frame with a handlebar bushing having a handlebar shaft therein with its distal ends having pivots fastened thereto with attached handlebar pivot linkage terminating in a handlebar fastener with handlebars extending therefrom.

6. The foldable three wheel land vehicle of claim 5, further providing said handlebar shaft with a pair of axle extension struts fastened to a respective side of said handlebar shaft with a struts shaft therebetween with each extension strut pivotally fastened to a pivot strut that is pivotally fastened to a respective subjacent pivotal strut section.

7. The foldable three wheel land vehicle of claim 6, further providing said rear wheels frame with a rotative steering linkage post having a channel therethrough.

8. The foldable three wheel land vehicle of claim 7, further providing said seat support with a steering linkage fastener downwardly extending from said seat support.

9. The foldable three wheel land vehicle of claim 8, further providing steering linkage extending between said steering linkage fastener through said rotative steering linkage post to the superjacent hinged section whereby pivoting the seat support moves the superjacent axle portion linearly left or right relative to the subjacent axle portion thereby changing the wheels camber simultaneously.

10. The foldable three wheel land vehicle of claim 9, wherein said steering linkage has a split rail with the stationary subjacent rail portion having longitudinal tracks thereon and the superjacent rail portion having track mating channels thereon extends when the rear axle is moved to a folded state with the mating tracks and channels maintaining guideway engagement between a folded and deployed position.

11. The foldable three wheel land vehicle of claim 10, further providing said rear wheels frame with latching for said axle extension linkage comprising a pivotal shaft having a pair of cavities that engage the struts shaft when in the folded position and again when in the deployed position with the pivotal shaft pivotally fastened to the rear wheels frame and a pivotal bar with a pivot therebetween with the pivot bar having a handle for raising the pivotal shaft disengaging the struts shaft thereby enabling use of the axle extension linkage.

12. The foldable three wheel land vehicle of claim 11, further providing shock absorbers pivotally fastened at one end to the superjacent hinged section and fixedly attached to a respective superjacent pivotal strut section.

13. The foldable three wheel land vehicle of claim 1, wherein said pedal assembly comprises pedal assembly mount having a throughbore for slidably mounting onto the front wheel frame; mount lock for securing the mount to a desired position on the front wheel frame; pedals and cranks driving a pedal assembly sprocket having and chain forming drive means for the front wheel.

14. The foldable three wheel land vehicle of claim 1, wherein said front wheel has a hub with a cogset mounted thereon and a derailleur mounted thereto with said chain extending through said derailleur engaging a desired sprocket of said cogset.

15. The foldable three wheel land vehicle of claim 1, further providing a front wheel electric hub motor and a battery providing a tricycle that can be manually operated through said pedal assembly or motor driven.
